(19) United States
(12) Patent Application Publication
(10) Pub. No.: US 2002/0181669 A1
(43) Pub. Date: Dec. 5, 2002

(54) Telephone device and translation telephone device

(76) Inventors: Sunao Takatori, Tokyo (JP); Hisanori Kiyomatsu, Tokyo (JP)

Correspondence Address: Darby & Darby, 805 Third Avenue, New York, NY, 10022, US

(21) Appl. No.: 10/149,175

(22) PCT Filed: Sep. 27, 2001
(86) PCT No.: PCT/JP01/08464

(30) Foreign Application Priority Data
Oct. 4, 2000 (JP) 2000-305227

(51) Int. Cl. H04M 1/64

(52) U.S. Cl. 379/88.06

(57) ABSTRACT

User operations when utilizing translation telephone service (translation) are simplified. By making possible voice recognition for limited speakers, voice recognition performance and translation accuracy are improved. When a translation key 73 for use of a translation telephone service is operated, a connection procedure execution unit 31 reads a connection procedure registered in advance in a connection procedure storage unit 83 to connect to a translation telephone device and to set the language to use. The automatic translation mode setting unit refers to the used language of the destination, which is set in advance in a telephone number storage unit 84, and to the history of use of the translation telephone service, which is stored in a call history storage unit 85, and automatically to set the use of the translation telephone service. When using the translation telephone service, voice recognition is performed by a voice recognition unit 33 incorporated within the telephone device 1, and a voice recognition result transmission unit 34 provides text information (text data) which is the recognition result to the translation telephone device.

### TECHNICAL FIELD

The present invention relates to a telephone device suitable for use in a translation (interpretation) telephone service, and a translation telephone device for providing a translation telephone service.

### BACKGROUND ART

Various technologies have been proposed for the translation (interpretation) of telephone conversations, such as the following. Japanese Patent Laid-open No. 5-334353 describes a voice translation communication method with the following configuration. Japanese-language voice messages are subjected to voice recognition by a Japanese-language voice recognition device, and the recognized content is translated into English by a Japanese-English translation device. The translated content together with the Japanese messages, which are encoded into signals, is transmitted to the English-language voice side via a communication interface. On the English-language side, the content is received via the communication interface, and the synthesized voice messages in English is pronounced by an English-language voice synthesis device, while also displaying the content of the Japanese message. On the English-language side, English voice pronounced in response to this is subjected to voice recognition by an English-language voice recognition device, the results are translated into Japanese by an English-Japanese translation device, and the translated content is transmitted, together with the English messages which are encoded into signals, to the Japanese-language side via the communication interface. On the Japanese-language side, the translated Japanese-language text is pronounced by a Japanese-language voice synthesis device, and the English messages are displayed.

Japanese Patent Laid-open No. 11-112665 describes a portable telephone system with the following configuration. A satellite for international portable telephone use is equipped with a translation expert system, a fuzzy inference system to eliminate vague words, a voice recognition system, and a voice synthesis system. Voice signals from a portable telephone in an originating region or delivery region are subjected to voice recognition, and the recognized content is converted into the language of the destination. The results are voice-synthesized and outputted to a portable telephone in the delivery region or in the originating region.

In Japanese Patent Laid-open No. 2000-206983, a technique is described with which the used language can be automatically specified by transmitting used-language information recorded in advance on recording media (for example, a Subscriber Identity Module (SIM) card) mounted in a terminal device, to an interpretation server (a server having translation functions which include functions for voice recognition, for machine translation and for voice synthesis).

In order to utilize a translation (interpretation) telephone service, it is necessary to send a signal for requesting the use of the service, a signal for connecting to the translation telephone device (interpretation server) and a signal for specifying the language, and therefore the user's operation of the telephone device is complex.

Also, conventional translation (interpretation) telephone services are configured such that voice recognition is performed on the side of the translation telephone device (interpretation server). Because of this, the voice recognition device must perform voice recognition without limitation of speakers (for unspecified speakers), so that the recognition performance is degraded compared with voice recognition with limitation of speakers.

The present invention was made in order to solve such problems, and has an object to provide a telephone device in which, by registering in advance in the telephone device the connection procedure when utilizing a translation (interpretation) telephone service, operations are simplified when utilizing the translation (interpretation) telephone service. Also, the present invention has further an object to provide a telephone device in which automatic utilization of a translation (interpretation) telephone service can be performed.

Further, the present invention also has an object to provide a telephone device comprising a voice recognition device, by which the voice of the user of the telephone device is recognized, and the results of the voice recognition are transmitted to a translation telephone device (interpretation server), so that voice recognition for limited speakers can be performed. Also, the present invention has an object to provide a telephone device in which, by transmitting individual identification information for the user of the telephone device (the caller) from the telephone device side to the translation telephone device (translation server), voice recognition for limited speakers can be performed on the translation telephone device (translation server) side, based on data relating to the voice of the caller (voice characteristic data and the like) registered in advance in the translation telephone device (translation server).

The present invention also has an object to provide a translation telephone device for providing a translation telephone service which, when text information instead of voice information is provided, is based on this text information. Also, the present invention has as an object to provide a translation telephone device which, by storing data relating to the voice of the user in association with an individual identification symbol to specify the user, is capable of performing voice recognition for limited speakers.

### DISCLOSURE OF THE INVENTION

In order to solve the above problems, a telephone device of the present invention is applied to a translation telephone service system in which a voice message in one language, inputted from the telephone device of the originating call, is translated into another language via a translation telephone device, and is outputted as a voice message by a telephone device at the destination call, and is characterized in comprising indication means for indicating the translation telephone service mode through operation of the above translation telephone device, storage means for storing information relating to the method of connection to the translation telephone device, and control means for performing connection with the translation telephone device based on the stored information of the storage means, when the translation telephone service mode is set by the above indication means.

Further, it is characterized in that said storage means stores information on the language used by the user of the telephone device and information on the language used by the destination of a call, associated with the telephone numbers of destinations, and, when the telephone number of the destination of the current call is stored in said storage means and the language used by the destination of the current call differs from the language used by the user, said indication means indicates to said translation telephone device that a connection should be made in translation telephone service mode between the language of the destination to the current call and the language of the user of the telephone device.

By this means, the telephone device of the present invention can automatically connect to the translation telephone device (translation server) through operation of, for example, an interpretation key provided in the operation unit.

In addition, when originating a call to a destination stored in the storage means, the translation telephone service can be used automatically. When a call arrives from a destination stored in the storage means and the originating-side telephone number is supplied to the telephone-set side, use of the translation telephone service can be set automatically when responding to the incoming call.

Also, when calling a destination for which the translation telephone service has used in the past, use of the translation telephone service is set automatically.

The control means of the telephone device of the present invention is characterized in that, when translation telephone service mode is set by the above indication means, the inputted voice information in one language is subjected to voice recognition and supplied as text information in the one language to the translation telephone device, and is further characterized in that, in voice recognition, the inputted voice information is treated as the voice information of a specified speaker to perform the voice recognition.

By this means, voice recognition can be performed for limited speakers, and the performance of voice recognition can be improved.

Also, a translation telephone device of the present invention is applied to a translation telephone service system, in which a voice message in one language inputted from the telephone device at the originating call is translated into another language via a translation telephone device, and voice is outputted from the telephone device at the destination call.

The translation telephone device of the present invention is characterized in comprising voice recognition means for recognizing voice information in one language and for outputting it as text information in that language, machine translation means for converting text information in one language into text information in another language, voice synthesis means for synthesizing voice information in this other language based on text information in the other language, and an input switching unit for supplying this voice information to the above voice recognition means when the input from the telephone device of the originating call is voice information and for supplying this text information to the above machine translation means when the input is text information.

By this means, when the telephone device comprises a voice recognition device, a translation telephone service can be provided, based on the voice recognition results on the telephone device side.

Also, a translation telephone device of the present invention is applied to a translation telephone service in which a voice message in one language inputted from the telephone device at the originating call is translated into another language via a translation telephone device and voice is outputted from the telephone device at the destination call. The translation telephone device of the present invention is characterized in comprising voice recognition means for recognizing voice information in one language, and for outputting it as text information in that language, machine translation means for converting text information in one language into text information in another language, a voice synthesis device for synthesizing voice information in this other language based on text information in the other language, and user voice data storage means for storing data relating to the voice characteristic of the user, in association with individual identification information to specify the user, and is further characterized in that the above voice recognition means performs voice recognition by using corresponding voice-related data stored in the above user voice data storage means, based on individual identification information supplied by the telephone device in the event of a conversation.

By this means, voice recognition of limited speakers can be executed on the translation telephone device (translation server) side, based on voice-related data for the caller (voice characteristic data and the like) registered in advance in the translation telephone device (translation server), so that the voice recognition performance can be improved.

### BRIEF DESCRIPTION OF THE DRAWINGS

FIG. 1 is a block diagram of a telephone device according to the present invention.

FIG. 2 is a block diagram of another telephone device according to the present invention.

FIG. 3 is a block diagram of a translation telephone device according to the present invention.

FIG. 4 is a block diagram of another translation telephone device according to the present invention.

FIG. 5 is a figure showing a mode of use of a translation telephone service.

FIG. 6 is a figure showing another mode of use of a translation telephone service.

In the drawings, 1, 11, 401, 320, 340, and 402 are telephone devices, 31 is a connection procedure execution unit, 32 is an automatic translation mode setting unit, 33 is a voice recognition unit, 34 is a voice recognition result transmission unit, 35 is an individual identification information transmission unit, 73 is a translation key, 81 is an identification information storage unit, 82 is a used-language storage unit, 83 is a connection procedure storage unit, 84 is a telephone number storage unit, 85 is a call history storage unit, 100, 200, 350, and 403 are translation telephone devices, 110 and 210 are Japanese-English translation devices, 111 and 121 are input switching units, 112 and 220 are Japanese-language voice recognition devices, 113 is a Japanese-English machine translation device, 114 is an English-language voice synthesis device, 120 and 230 are English-Japanese translation devices, 122 and 240 are English-language voice synthesis devices, 123 is an English-Japanese machine translation device, 124 is a Japanese-language voice synthesis device, 222 and 242 are voice dictionary management units, 223 and 243 are voice dictionary units comprising a user voice data storage unit, 225a to 225n are voice dictionaries for individual, comprising user voice data storage units, and 360 is a network.

### BEST MODE FOR CARRYING OUT THE INVENTION

Below, preferred modes of the present invention are explained in detail, referring to the attached drawings. In explanations of the modes of the present invention, a portable telephone is described as a specific example of a telephone device.

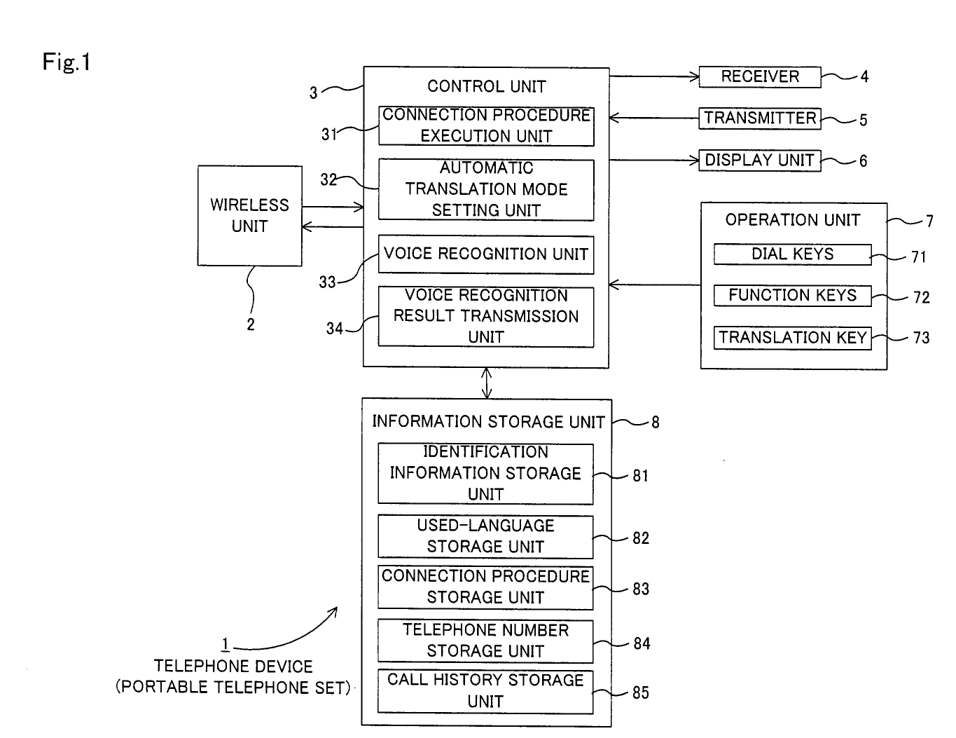

FIG. 1 is a block diagram of a telephone device (portable telephone set) of the present invention. The telephone device (portable telephone set) 1 comprises a wireless unit 2, a control unit 3, a receiver 4, a transmitter 5, a display unit 6, an operation unit 7 and an information storage unit 8.

The wireless unit 2 comprises a receiver unit, a transmitter unit, a frequency synthesizer unit, an antenna sharing component and an antenna unit. The control unit 3 is realized by program control using a microcomputer system. This control unit 3 comprises various circuitries to control the functions of a portable telephone set such as a voice signal processing unit, a main control unit, a user interface unit and the like. In order to utilize a translation telephone service, this control unit 3 further comprises a connection procedure execution unit 31, an automatic translation mode setting unit 32, a voice recognition unit 33 and a voice recognition result transmission unit 34.

The operation unit 7 comprises dial keys 71, various function keys 72 and a translation key 73 for using the translation telephone service.

The information storage unit 8 has a nonvolatile memory or the like, and comprises an identification information storage unit 81, a used-language storage unit 82, a connection procedure storage unit 83, a telephone number storage unit 84 and a call history storage unit 85.

The identification information storage unit 81 stores identification information (ID information) for identifying the user of the portable telephone set 1. In general, portable telephones are used personally, and therefore a single set of identification information may be stored in one portable telephone set 1. Consequently, the identification information may be unique to the portable telephone set 1.

The used-language storage unit 82 stores information concerning the language used by the user of the portable telephone set 1. In this example of the present invention, Japanese is registered in the used-language storage unit 82. When the registration key of the operation unit 7 or the like is operated to start the registration mode, and a used language is selected from a registration menu displayed on the display unit 6, “Japanese”, “English”, “German”, and other languages are displayed on the display unit 6. By selecting the language used by the user of the portable telephone set from among these and then performing a registration operation, the used language can be registered.

The connection procedure storage unit 83 stores a procedure for connecting to a translation telephone device (translation server) and a procedure for specifying a used language. For example, a specific telephone number and the like may be set for the translation telephone service. When, after dialing this specific telephone number and connecting to the translation telephone device (translation server), the used language on the side of the telephone device 1 and the used language on the destination call side are specified, a procedure is recorded in the connection procedure storage unit 83 for specifying the telephone number of the translation telephone device (translation server) and the used language. When a telephone number and sub-address are set for each language to be translated, languages for translation and telephone numbers are associated and stored in the connection procedure storage unit 83.

The telephone number storage unit 84 stores the name, title or the like of the destination call which are associated with one another, the telephone number and the used language of the destination. By selecting a telephone directory in the above-described registration mode, the names, telephone numbers, and used languages of destinations can be registered, modified, or deleted.

The call history storage unit 85 stores the dates and times of calls, the telephone numbers or names of destinations, whether a translation telephone service has been used, and the used language of the destination, which are associated with one another. The call history is automatically generated by the control unit 3.

Next, the operation of the telephone device (portable telephone set) 1 is explained, together with an example of user operation. When using a translation telephone service, the user of the telephone device 1 depresses the translation key 73, and then inputs the telephone number of the destination by using the dial keys 71. When the control unit 3 recognizes, through the operation of translation key 73, that a request has been issued to utilize the translation telephone service, it searches the telephone number storage unit 84 and call history storage unit 85 based on the inputted telephone number for the destination, and obtains the used language, if the used language is registered for the destination. If the control unit 3 is not able to obtain a used language for the destination as a result of a search for the telephone number storage unit 84 and call history storage unit 85, a picture is displayed on the display unit 6 for inputting the used language of the destination to prompt the user of the telephone device 1 to input the used language of the destination.

When the control unit 3 obtains the used language for the destination through the above search results or through an inputting operation by the user of the telephone device 1, the used language of the user of the telephone device 1 stored in the used-language storage unit 82 is obtained. When the control unit 3 obtains the used languages of the user of the telephone device 1 and the destination, it reads, from the connection procedure storage unit 83, a procedure for connection to a translation telephone device (translation server) capable of interpreting in both directions between these languages. For example, if the used language of the user of the telephone device 1 is Japanese, and the used language of the destination is English, the control unit 3 reads from the connection procedure storage unit 83 a procedure for connection to a translation telephone device (translation server) which provides Japanese-English bi-directional interpreting service.

Next, the control unit 3 causes the connection procedure execution unit 31 to read and to execute the connection procedure. For example, if the procedure for the use of a translation telephone service involves sequential transmission of a service number requesting use of the translation telephone service, information for specifying each of the languages, and the telephone number of the destination, the connection procedure execution unit 31 executes this procedure. Also, if the procedure to use a translation telephone service involves, first, circuit connection to the translation telephone device (translation server), and then transmission of each of the used languages and the telephone number of destination in response to a request from the translation telephone device (translation server), this procedure is executed by the connection procedure execution unit 31.

When originating a call to a destination registered in the telephone number storage unit 84, the translation telephone service can be automatically used even if the translation key 73 is not operated. When the user of the telephone device 1 selects and specifies a destination registered in the telephone number storage unit 84, the automatic translation mode setting unit 32 obtains the used language of the specified destination from the telephone number storage unit 84. Then, the automatic translation mode setting unit 32 judges whether it is necessary to use a translation telephone service, based on the used languages of the user of the telephone device 1 and the used language of the destination stored in the used-language storage unit 82. If the two used languages are different, the automatic translation mode setting unit 32 judges that a translation telephone service must be used, and causes the connection procedure execution unit 31 to execute a procedure to use a translation telephone service.

In addition, the automatic translation mode setting unit 32 may cause the display unit 6 to display a message, indicating that a translation telephone service is to be utilized when the two used languages are different. If the user of the telephone device 1 performs an input operation so as to agree with this, the connection to the translation telephone service is made, and if the user performs an input operation indicating that no translation telephone service is to be used, normal call is made.

When a call arrives at the telephone device 1, the control unit 3 causes the telephone number of the originating call provided via the network, to be displayed on the display unit 6, and also causes the fact of the incoming call via the receiver 4 or via an incoming call indicator unit, not shown, to be displayed. The automatic translation mode setting unit 32 searches the telephone number storage unit 84 and call history storage unit 85 based on the telephone number of the originating call, and judges whether it is necessary to use a translation telephone service. If the automatic translation mode setting unit 32 judges that use of a translation telephone service is necessary, based on the fact that the used languages of both parties are different, or the fact that the call history indicates that a translation telephone service has been used in the past, a signal indicating the intention of using a translation telephone service is sent when the user of the telephone device 1 performs an operation to respond to the incoming call. On the side of the network, not shown, if a signal indicating the intention of using a translation telephone service is supplied from the telephone device 1 of the call-receiving side, the incoming call is connected to the telephone device 1 via the translation telephone device (translation server).

If the automatic translation mode setting unit 32 judges, upon incoming call, that it is necessary to use a translation telephone service, the message to the effect may be displayed on the display unit 6, and when the user of the telephone device 1 performs an operation to agree with the use of the translation telephone service, a signal may be supplied to the network side indicating the intention of using the translation telephone service.

If an incoming call is received via a translation telephone device (translation server), and information indicating that the incoming call utilizes a translation telephone service via the network is supplied to the telephone device 1, the control unit 3 may cause the display unit 6 to display to the effect that the incoming call utilizes the translation telephone service.

Further, when an incoming call is via a translation telephone device (translation server), if a signal indicating the intention of using the translation telephone service is sent from the telephone device 1 to the network, the network side ignores the signal sent from the telephone device 1 indicating the intention of using the translation telephone service.

When it becomes possible to perform conversation via the translation telephone device (translation server), the control unit 3 starts the voice recognition unit 33 and the voice recognition result transmission unit 34, and notifies the network side that uplink signals from the telephone device 1 to the network side are data signals.

The voice of the user of the telephone device 1 is converted into voice signals by the transmitter 5, and the voice signals are supplied to the voice recognition unit 33 through a low-frequency amplifier and A/D converter, not shown. The voice recognition unit 33 comprises a DSP, a voice recognition program and the like. This voice recognition unit 33 recognizes the voice of the user of the telephone device 1, and converts the recognized content to text data, which is then outputted. The voice recognition result transmission unit 34 causes the wireless unit 2 to transmit the text data outputted by the voice recognition unit 33, based on a data communication protocol or the like set in advance.

The telephone device 1 is a portable telephone, and in general is often used personally. Therefore this voice recognition unit 33 is provided with a voice data storage unit for storing data relating to the voice of specified speakers. By using the voice-related data stored in this voice data storage unit, the voice recognition performance can be improved. For this reason, the voice recognition program of the voice recognition unit 33 is also provided with functions for learning characteristic data, parameters of the speaker's voice and the like and for storing the learned contents in this voice data storage unit occasionally, as supplementary data for voice recognition. The content spoken in Japanese by the user of the telephone device 1, for example, is subjected to voice recognition by the voice recognition unit 33 and converted into text data, which is supplied to the translation telephone device (translation server) via the network. On the side of the translation telephone device (translation server), syntactic analysis or the like is performed by a machine translation device based on the text data supplied from the telephone device 1, and the Japanese content is translated into, for example, English. The synthesized voice of the translated English is then generated by an English-language voice synthesis device, and is supplied to the destination of the call. The content spoken in English by the destination is translated into Japanese by the translation telephone device (translation server), and the translated Japanese voice is supplied to the telephone device 1. By such processes, it is possible to perform the conversation via a translation telephone device (translation server).

In order to set the translation mode automatically, the following configuration may be adopted as well. A country-language storage unit, which records country numbers in association with the official language of each country, is provided within the information storage unit 8. The automatic translation mode setting unit 32 searches the above country-language storage unit, based on the country number of the destination telephone number inputted from the telephone device 1 or the incoming call supplied by the network to obtain the official language of the destination. If the official language of the destination obtained by using the country number and the used language of the user of the telephone device 1 are different, the automatic translation mode setting unit 32 judges that it necessary to use a translation telephone service. The automatic translation mode setting unit 32 then causes the connection procedure execution unit 31 to execute a procedure in order to use a translation telephone service.

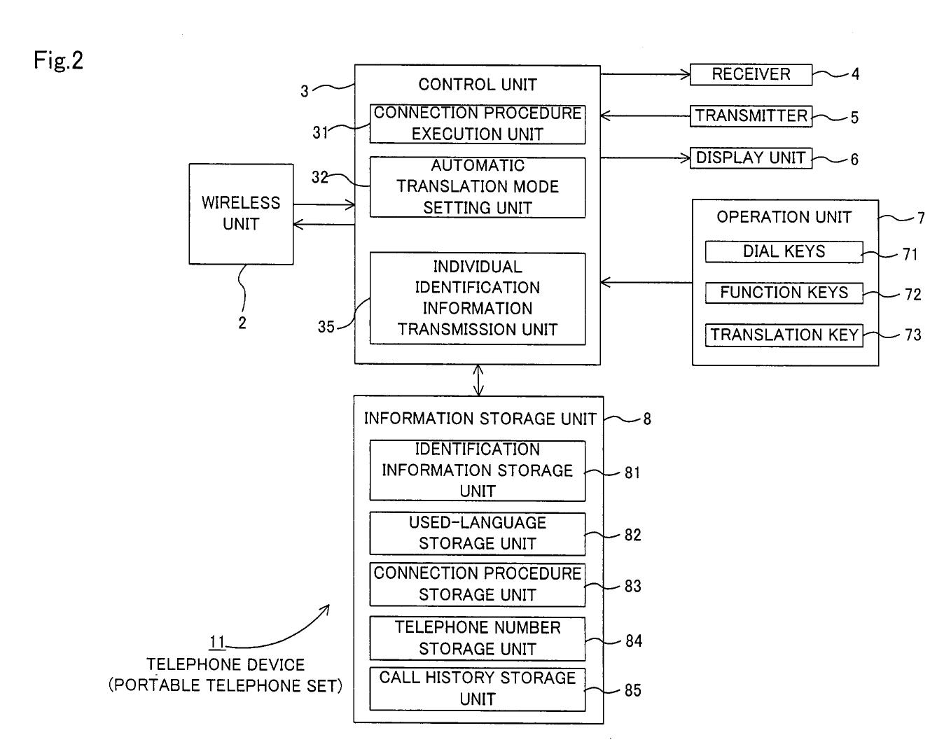

FIG. 2 is a block diagram of another telephone device (portable telephone set) of the present invention. The telephone device (portable telephone set) 11 shown in FIG. 2 differs from the telephone device (portable telephone set) 1 shown in FIG. 1 in the point that it comprises an individual identification information transmission unit 35 within the control unit 3. This telephone device (portable telephone set) 11 does not comprise a voice recognition unit. Hence when using a translation telephone service, voice recognition is performed on the side of the translation telephone device (translation server). Voice recognition may be performed for unspecified speakers, or for specified speakers. By performing voice recognition based on the voice characteristics of specified speakers, the recognition performance can be improved.

When the telephone device 11 is connected to a translation telephone device (translation server), the individual identification information transmission unit 35 takes out identification information to identify the user of the telephone device 1 registered in advance in the identification information storage unit 81, and transmits this identification information to the translation telephone device (translation server). By such processes, the translation telephone device (translation server) can identify the user of the telephone device 11, based on identification information provided from the telephone device 11. When voice-related data of the user identified based on identification information is stored in the voice data storage unit on the side of the translation telephone device (translation server), the translation telephone device (translation server) can improve the performance of voice recognition by using voice-related data of the user. Also, characteristics of the voice of the user can be extracted and stored in the voice data storage unit. Voice characteristic data and parameters of the user can be learned, and based on the learned content, voice-related data stored in the voice data storage unit can be updated.

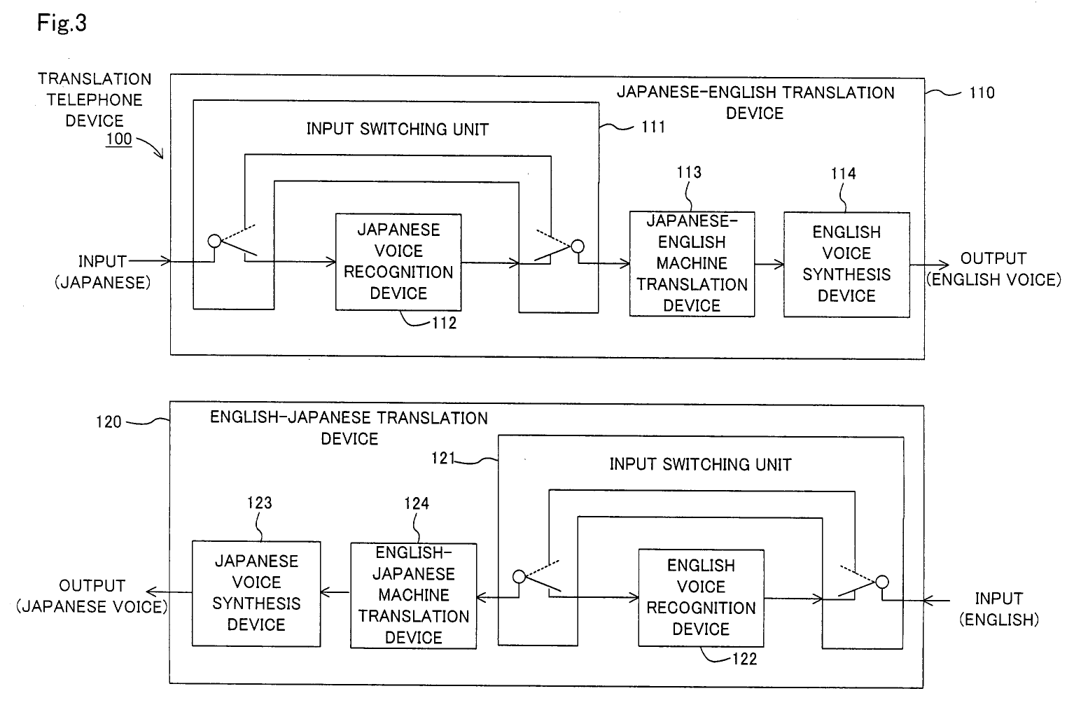

FIG. 3 is a block diagram of a translation telephone device (translation server) of the present invention. FIG. 3 shows a translation telephone device (translation server) which performs translation of Japanese and English in both directions (translation). This translation telephone device 100 comprises a Japanese-English translation device 110 and an English-Japanese translation device 120. The Japanese-English translation device 110 comprises an input switching unit 111, Japanese-language voice recognition device 112, Japanese-English machine translation device 113, and English-language voice synthesis device 114. The English-Japanese translation device 120 comprises an input switching device 121, English-language voice recognition device 122, English-Japanese machine translation device 123, and Japanese-language voice synthesis device 124.

The input switching unit 111 comprises an input information judgment unit (not shown) which judges whether signals inputted to the Japanese-English translation device 110 (input signals) comprise voice information or text information. When inputted signals comprise voice information, the input switching unit 111 provides the voice information to the Japanese-language voice recognition device 112, and provides outputted signals from the Japanese-language voice recognition device 112 to the Japanese-English machine translation device 113. When inputted signals comprise text information, the input switching unit 111 provides the text information to the Japanese-English machine translation device 113.

The Japanese-language voice recognition device 112 recognizes Japanese-language voice content, and outputs the recognized content as Japanese-language text information. This Japanese-language text information is supplied to the Japanese-English machine translation device 113. The Japanese-English machine translation device 113 performs syntactic analysis of the Japanese message based on Japanese-language text information, and translates the Japanese-language content into English to output English-language text information. The English-language text information is supplied to the English-language voice synthesis device 114. The English-language voice synthesis device 114 synthesizes and outputs English-language voice content based on the English-language text information.

The English-Japanese translation device 120 causes the English-language voice recognition device 122 to perform voice recognition of English-language voice inputted to output English-language text information and causes the English-Japanese machine translation device 123 to translate the English-language text information into Japanese-language text information. It causes the Japanese-language voice synthesis device 124 to vocalize Japanese-language voice content.

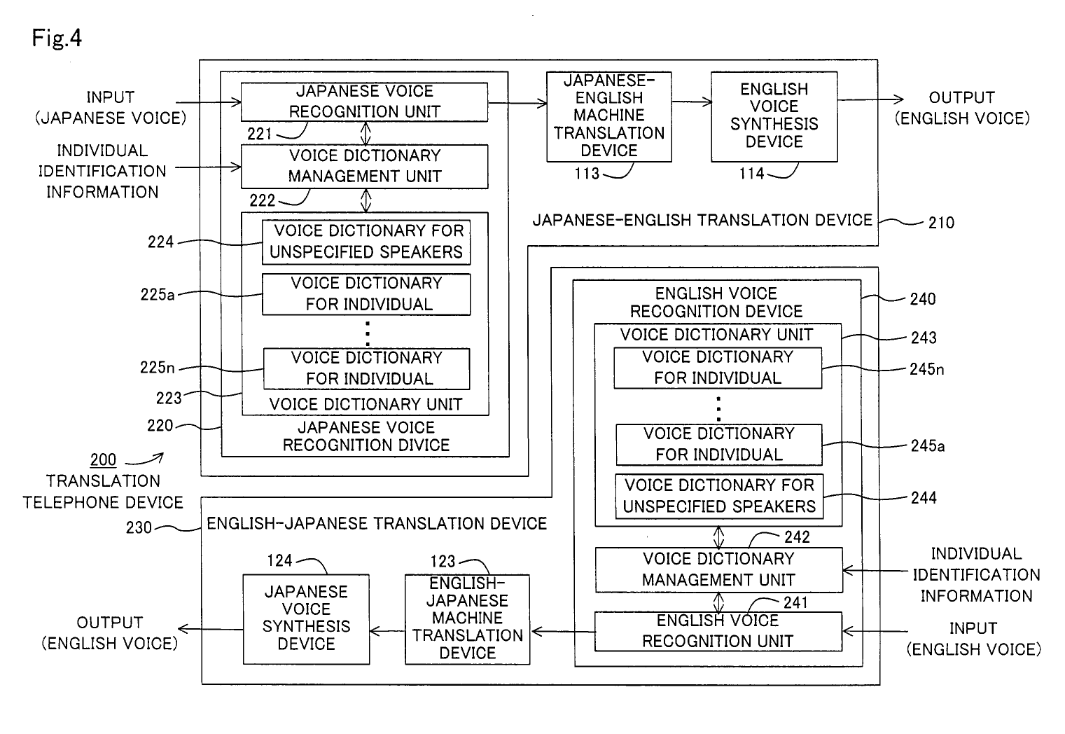

FIG. 4 is a block diagram of another translation telephone device (translation server) of the present invention. FIG. 4 shows a translation telephone device (translation server) which translates between Japanese and English in both directions (translation). This translation telephone device 200 comprises a Japanese-English translation device 210 and an English-Japanese translation device 230.

The Japanese-English translation device 210 comprises a Japanese-language voice recognition device 220, a Japanese-English machine translation device 113, and an English-language voice synthesis device 114. The Japanese-language voice recognition device 220 comprises a Japanese-language voice recognition unit 221, a voice dictionary management unit 222, and a voice dictionary unit 223. Here, the voice dictionary unit 223 constitutes the user voice data storage unit described in the Scope of Claims. This voice dictionary unit 223 comprises a voice dictionary for unspecified speakers 224 and a plurality of voice dictionaries for individual 225a to 225n. When individual identification information is not provided, the voice dictionary management unit 222 selects the voice dictionary for unspecified speakers 224. When individual identification information is not provided, the Japanese-language voice recognition unit 221 employs the voice dictionary for unspecified speakers 224 to perform Japanese-language voice recognition, and outputs the recognized content as Japanese-language text information. When individual identification information is provided, the voice dictionary management unit 222 checks whether there exists in the voice dictionary unit 223 a voice dictionary for individual corresponding to the individual identification information.

If a voice dictionary for individual corresponding to the individual identification information does not exist (is not registered), the voice dictionary management unit 222 selects the voice dictionary for unspecified speakers 224, and provides a request to extract the characteristics of Japanese-language voice inputted to the Japanese-language voice recognition unit 221. The Japanese-language voice recognition unit 221 performs voice recognition by using the voice dictionary for unspecified speakers 224. It also extracts characteristic data of the Japanese-language voice content being subjected to voice recognition, and provides the voice dictionary management unit 222 with the extracted characteristic data. The voice dictionary management unit 222 registers the characteristic data of Japanese-language voice content provided by the Japanese-language voice recognition unit 221, associated with the individual identification information, in a voice dictionary for individual (a dictionary for individual is newly created).

If a voice dictionary for individual corresponding to the individual identification information exists, the voice dictionary management unit 222 selects the voice dictionary for individual corresponding to the individual identification information, and provides a request to learn the characteristics of the Japanese-language voice to the Japanese-language voice recognition unit 221. The Japanese-language voice recognition unit 221 performs voice recognition by using the voice dictionary for individual corresponding to the individual identification information, and also learns the characteristics of the Japanese-language voice content for which voice recognition is being performed, and adds new voice data to the voice dictionary for individual, or, when the need arises to modify registered voice data, provides the voice data to the voice dictionary management unit 222. The voice dictionary management unit 222 performs additions or updates in the voice dictionary for individual based on voice data supplied by the Japanese-language voice recognition unit 221.

In this way, when individual identification information is provided, the Japanese-language voice recognition device 220 operates as a limited-speaker type voice recognition device, and accumulates voice characteristics of the user in a dictionary for individual, so that voice recognition performance can be improved.

Content subjected to voice recognition by the Japanese-language voice recognition device 220 is provided, as Japanese-language text information, to the Japanese-English machine translation device 113, and is translated into English-language text information by the Japanese-English machine translation device 113. The English-language voice is then vocalized by the English-language voice synthesis device 114.

The English-Japanese translation device 230 comprises an English-language voice recognition device 240, English-Japanese machine translation device 123, and Japanese-language voice synthesis device 124. The English-language voice recognition device 240 comprises an English-language voice recognition unit 241, a voice dictionary management unit 242, and a voice dictionary unit 243. The voice dictionary unit 243 comprises a voice dictionary for unspecified speakers 244, and a plurality of voice dictionaries for individual 245a to 245n. The English-language voice recognition device 240 performs the voice recognition of English-language voice, and outputs the recognized content as English-language text information. The English-Japanese machine translation device 123 translates English-language text information into Japanese-language text information, and the Japanese-language voice synthesis device 124 synthesizes and outputs Japanese-language voice content based on Japanese-language text information.

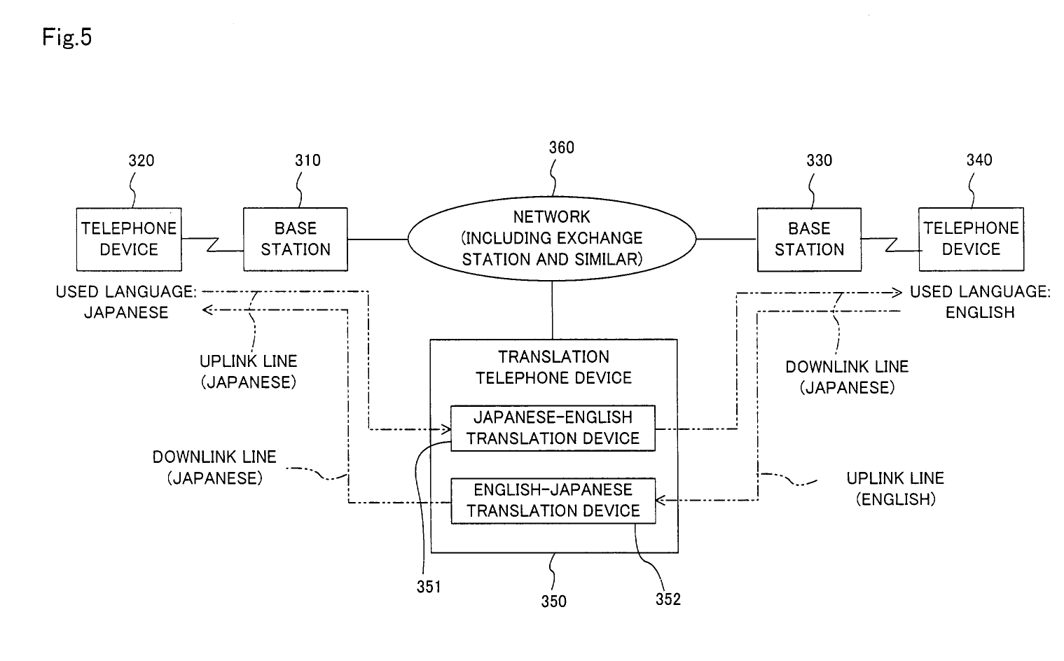

FIG. 5 shows one mode of use of a translation telephone service. This figure shows schematically such a mode that a first telephone device 320 within the service area of a first base station 310 and a second telephone device 340 within the service area of a second base station 330 utilize a translation telephone service via a translation telephone device 350. The symbol 360 denotes a network.

The exchange station or the like for controlling line connections connects the lines of the telephone devices 320 and 340 to the translation telephone device 350, based on a request for utilization of the translation telephone service sent from either of the telephone devices 320 or 340. When the language spoken by the user of the first telephone device 320 is Japanese, and the language spoken by the user of the second telephone device 340 is English, the uplink of the first telephone device 320 is connected to the input side of the Japanese-English translation device 351, and the downlink of the second telephone device 340 is connected to the outputted side of the Japanese-English translation device 351. By such construction, the Japanese content at the first telephone device 320 is converted into English-language voice content by the Japanese-English translation device 351, which is supplied to the second telephone device 340. The uplink of the second telephone device 340 is connected to the input side of the English-Japanese translation device 352, and the downlink of the first telephone device 320 is connected to the outputted side of the English-Japanese translation device 352. By such construction, English-language content at the second telephone device 340 is converted into Japanese-language voice content by the English-Japanese translation device 352, which is supplied to the first telephone device 320.

The exchange station or control station for controlling the network 360 performs line connections through the translation telephone device 350 based on requests for use of the translation telephone service provided from a telephone device at the time of initiation of a conversation, when a call is originated or when responding to an incoming call. Also, while each telephone device is in a state of normal conversation (without passing through the translation telephone device 350), if a request for use of the translation telephone service is sent from either of the telephone devices, the above exchange station or control station modifies the state of the line connection so as to pass through the translation telephone device 350. Further, in a state that the translation telephone service is being provided, if a request to halt the use of the translation telephone service is sent from either of the telephone devices, the above exchange station or control station modifies the line connection to the state of normal conversation (not passing through the translation telephone device 350).

If the telephone devices 320 and 340 comprise a voice recognition device and voice recognition results are sent as text information, the base stations 310, 330 and the network 360 set the uplink line so as to perform data communication.

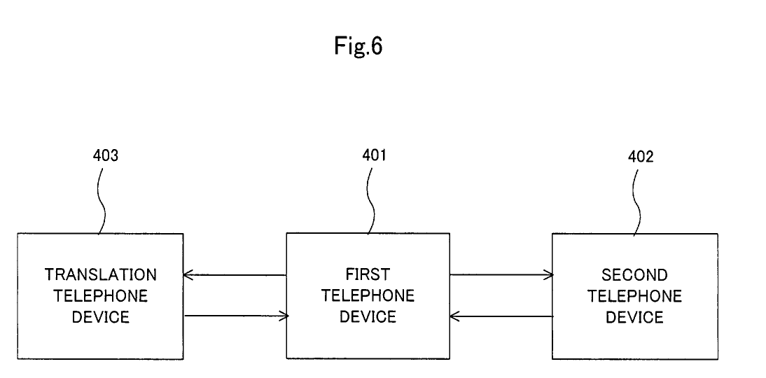

FIG. 6 is a figure showing another mode of use of a translation telephone service. The first telephone device 401 comprises a so-called multi-call function to establish a plurality of communications simultaneously. When using the translation telephone service, the first telephone device 401 establishes communication with a second telephone device 402, and also establishes communication with the translation telephone device 403. The first telephone device 401 converts voice content to text data by means of a voice recognition unit incorporated within the telephone device 401, and transmits the text data to the translation telephone device 403. The translation telephone device 403 translates the text data into the language of the destination side, and transmits synthesized voice content in the destination's language to the first telephone device 401. The first telephone device 401 transmits the synthesized voice content in the destination's language (voice content after translation), provided by the translation telephone device 403, to the second telephone device 402. The first telephone device 401 provides the translation telephone device 403 with the voice content transmitted from the second telephone device 402 to obtain the translated voice content.

In this mode of the invention, portable telephone sets have been employed as specific examples of telephone devices, but the telephone devices may be, for example, fixed telephone sets connected to an ISDN network.

Industrial Applicability

As explained above, a telephone device of the present invention comprises indication means for indicating the translation telephone service mode through operation of a translation telephone device, storage means for storing information relating to the method of connection to the translation telephone device, and control means for performing connection with the translation telephone device based on storage information in the storage means when translation telephone service mode is set by the above indication means. Therefore it is possible to use the translation telephone service with simple user operation.

Further, according to the translation telephone device of the present invention, said storage means stores information on the language used by the user of the telephone device and information on the language used by the destination of a call, associated with the telephone numbers of destinations, and, when the telephone number of the destination of the current call is stored in said storage means and the language used by the destination of the current call differs from the language used by the user, said indication means indicates to said translation telephone device that a connection should be made in translation telephone service mode between the language of the destination to the current call and the language of the user of the telephone device. Therefore, it is possible to use the translation telephone service without special operations.

Further, a translation telephone device of the present invention is applied to a translation telephone service system, such that voice content in a first language, inputted from the telephone device of the origin of a call, is translated into another language via the translation telephone device and outputted as voice content from the telephone device of the destination call. The translation telephone device of the present invention comprises voice recognition means for recognizing voice information in one language and for outputting it as text information in that language, machine translation means for converting text information in the language into text information in another language, voice synthesis means for synthesizing voice information in the other language based on the text information in the other language, and, an input switching unit for providing this voice information to the above voice recognition means when the input from the telephone device at the originating call is voice information and for providing this text information to the above machine translation means when the input is text information. If the telephone device comprises a voice recognition device, the translation telephone service can be provided based on voice recognition results on the telephone device side.

Further, a translation telephone device of the present invention is applied to a translation telephone service system, such that voice content in a first language, inputted from the telephone device of the origin of a call, is translated into another language via the translation telephone device and outputted as voice content from the telephone device of the destination call. The translation telephone device of the present invention comprises voice recognition means for recognizing voice information in one language and for outputting it as text information in that language, machine translation means for converting text information in the language into text information in another language, a voice synthesis device for synthesizing voice information in the other language based on the text information in the other language, and, user voice data storage means for storing individual identification information to identify a user in association with voice-related data unique to the user. In addition, the above voice recognition means performs voice recognition by using corresponding voice-related data stored in the above user voice data storage means, based on individual identification information provided by a telephone device in the event of a conversation. Hence limited-speaker voice recognition can be performed, and by performing voice recognition for limited speakers the performance of voice recognition can be improved, and consequently the accuracy of translation can be enhanced.

1. A telephone device which is applied in a translation telephone service system in which voice in one language inputted from the telephone device at the originating call, is translated into another language by means of a translation telephone device and outputted as voice from the telephone device at the destination call, comprising,
indication means for indicating the translation telephone service mode through operation of said translation telephone device,
storage means for storing information relating to the method of connection to the translation telephone device, and
control means for performing connection with the translation telephone device based on the stored information of the storage means, when the translation telephone service mode is set by said indication means.

2. The telephone device according to claim 1, characterized in that said storage means stores information on the language used by the user of the telephone device and information on the language used by the destination of a call, associated with the telephone numbers of destinations, and, when the telephone number of the destination of the current call is stored in said storage means and the language used by the destination of the current call differs from the language used by the user, said indication means indicates to said translation telephone device that a connection should be made in translation telephone service mode between the language of the destination to the current call and the language of the user of the telephone device.

3. The telephone device according to claim 1, characterized in that when the translation telephone service mode is set by said indication means, said control means subjects the inputted voice information in a first language to voice recognition, and provides the result as text information in the first language to the translation telephone device.

4. The telephone device according to claim 3, characterized in that, when voice recognition is performed by said control means, the inputted voice information is subjected to voice recognition as voice information of a specific speaker.

5. A translation telephone device which is applied in a translation telephone service system in which voice in one language inputted from a telephone device at the originating call, is translated into another language by means of the translation telephone device and outputted as voice from the telephone device at the destination call, comprising,
voice recognition means for performing voice recognition on voice information in one language and for outputting the results as text information in the language,
machine translation means for converting text information in one language into text information in another language,
voice synthesis means for synthesizing voice information in the other language based on text information in the other language, and
an input switching unit for providing the voice information to said voice recognition means, when the input from the telephone device at the originating call is voice information, and for providing the text information to said machine translation means, when the input is text information.

6. A translation telephone device which is applied in a translation telephone service system in which voice in one language inputted from a telephone device at the originating call, is translated into another language by means of the translation telephone device and it is outputted as voice from the telephone device at the destination call, comprising,
voice recognition means for performing voice recognition on voice information in one language and for outputting the results as text information in the language,
machine translation means for converting text information in one language into text information in another language,
a voice synthesis device for synthesizing voice information in the other language based on text information in the other language, and
user voice data storage means for storing individual identification information to identify users in association with voice-related data unique to the users, wherein said voice recognition means performs voice recognition using corresponding voice-related data stored in said user voice data storage means, based on individual identification information provided from a telephone device on conversation.
